(19) United States
(12) Patent Application Publication
(10) Pub. No.: US 2026/0016009 A1
(43) Pub. Date: Jan. 15, 2026

(54) SCROLL VACUUM PUMP AND METHOD FOR PRODUCING A SCROLL VACUUM PUMP

(71) Applicant: Pfeiffer Vacuum Technology AG, Asslar (DE)

(72) Inventors: Erhard HARAPAT, Asslar (DE); Lars PAULI, Solms (DE); Jonas BECKER, Bischoffen (DE); Wolfgang SOEHNGEN, Waldsolms (DE)

(73) Assignee: Pfeiffer Vacuum Technology AG, Asslar (DE)

(21) Appl. No.: 19/220,243

(22) Filed: May 28, 2025

(30) Foreign Application Priority Data
Jul. 15, 2024 (EP) 24188690

(51) Int. Cl. F04C 18/02; B23C 3/16

(52) U.S. Cl. CPC F04C 18/0215; B23C 3/16; F04C 2230/10; F04C 2240/40

(57) ABSTRACT

A scroll vacuum pump includes a pump system having a stationary spiral component and a movable spiral component cooperating with the stationary spiral component in a pump-active manner, a drive shaft that rotates about an axis of rotation during operation and that has an eccentric section for driving the movable spiral component, and an electric drive motor for the drive shaft. The movable spiral component includes a spiral arrangement, which has spiral walls, spiral grooves bounded by the spiral walls and a spiral base forming the base of the spiral grooves, and a support for the spiral arrangement. The support cooperates with the eccentric section of the drive shaft. The stationary spiral component includes a spiral arrangement, which has spiral walls and a spiral base, and a support for the spiral arrangement.

The invention relates to a scroll vacuum pump comprising a pump system that comprises a stationary spiral component and a movable spiral component cooperating with said stationary spiral component in a pump-active manner; a drive shaft that rotates about an axis of rotation during operation and that has an eccentric section for driving the movable spiral component; and an electric drive motor for the drive shaft, wherein the movable spiral component comprises a spiral arrangement, which has spiral walls, spiral grooves bounded by said spiral walls and a spiral base forming the base of said spiral grooves, and a support for the spiral arrangement, said support cooperating with the eccentric section of the drive shaft, and wherein the stationary spiral component comprises a spiral arrangement, which has spiral walls and a spiral base, and a support for the spiral arrangement.

The invention furthermore relates to a method for producing such a scroll vacuum pump.

Scroll vacuum pumps are generally known, e.g. from EP 3 153 708 A2, EP 3 617 511 A2, EP 3 647 599 A2, EP 4 174 285 A1 and EP 4 253 720 A2.

A scroll vacuum pump is a displacement pump that compresses against atmospheric pressure and that can be used as a compressor, among other things. A scroll vacuum pump can be used to generate a vacuum in a recipient that is connected to a gas inlet of the scroll vacuum pump.

Scroll vacuum pumps are also called spiral vacuum pumps or spiral conveying devices. The underlying pumping principle of a scroll vacuum pump is generally known from the prior art and is therefore explained briefly below.

Typically, the pump system of a scroll vacuum pump has two spiral cylinders that are nested or inserted into another, for example Archimedean spiral cylinders, that are also simply referred to as spirals. Each spiral cylinder in this respect comprises at least one spiral wall having a support, in particular a plate-shaped support, provided at an end face of the spiral wall, wherein the outer windings of the spiral cylinder, for example the two or three outermost windings of the spiral cylinder, can be formed by wall sections that each have a constant spacing from the center of the spirals in the peripheral direction. Even if, strictly speaking, these wall sections do not form spiral sections but rather circular sections, they are attributed to the spiral in the context of the present disclosure and are referred to as windings of the spiral.

The spiral cylinders are in this respect inserted into one another such that the two spiral cylinders sectionally enclose crescent-shaped or sickle-shaped volumes (pumping spaces). One of the two spirals is in this respect arranged in an unmovable or stationary manner in the housing of the pump, whereas the other spiral together with its support can be moved on a circular path via the eccentric section of the drive shaft so that this spiral together with its support is also called an orbiter. This movable spiral component thus performs a so-called centrally symmetrical oscillation, which is also called “orbiting” or “wobbling”. A crescent-shaped volume (pumping space) enclosed between the spiral cylinders continues to migrate increasingly inwardly within the spirals during the orbiting of the movable spiral component, whereby, by means of the migrating volume, the process gas to be pumped is conveyed radially inwardly from a radially outwardly disposed gas inlet of the pump system to a gas outlet of the pump system that is in particular located at the spiral center.

The manufacture of the spiral components of scroll vacuum pumps involves a great deal of effort since in particular the spiral walls have to be produced with a very high precision. Predefined production tolerances may not be exceeded since even slight dimensional deviations during the operation of the scroll vacuum pump can lead to a so-called gap bridging, which can result in wear and noise emissions. Elastic deformations of the spiral walls at their free end sections were recognized as one cause of the lack of dimensional stability. If the spiral walls are produced by a chip-forming machining and e.g. a rotating end mill cutter is in this respect pressed during the machining against the radial inner side or against the radial outer side of the spiral wall to be produced, the spiral wall is then deflected due to its elastic deformability. As a result, less material is removed from the respective wall than under otherwise identical conditions with a stiffer spiral wall that is not deflected or is deflected to a lesser extent. When the machining tool is removed, the spiral wall springs back into its original position again. Due to the smaller material removal, it may occur that the predefined production tolerance is not maintained.

Such spring-back effects occur to a particularly pronounced degree at the end sections of the spiral walls since the spiral walls have less rigidity there than at wall sections arranged upstream of the free end sections. It has been observed that these spring-back effects can severely impair the dimensional stability and that the machined spiral wall springs back beyond a respective production tolerance at its end sections.

Therefore, these spring-back effects are also problematic since they complicate the manufacturing process in a series production of spiral components. In practice, the dimensional stability of each individual spiral component is automatically checked immediately after its production, e.g. using a coordinate measurement machine. On the basis of the checking measurement, settings of the machine tool are corrected if necessary in order, for the next spiral component to be produced, to adapt the contours expected based on the machining to the desired contours so that they are within the respective production tolerances. The correction algorithms used in practice cannot consider the aforementioned spring-back effects and are therefore interfered with in their interpretation of the correction measurements by these effects, which has the result that no fast automatic correction setting of the processing machine from spiral component to spiral component is possible. Instead, the respective operator must manually intervene in the evaluation of the correction measurements, for example, by ignoring the sections of the workpiece affected by spring-back effects, i.e. in particular the free end sections of the spiral walls, when evaluating the correction measurements or by considering said sections in another way.

This makes the manufacturing process much more time-consuming and thus considerably more expensive.

It is the object of the invention to provide a scroll vacuum pump and a method for its manufacture, which enable a simple, fast and cost-effective production of components of scroll vacuum pumps, such as in particular of the spiral components with a high dimensional stability, wherein in particular a fast automatic check of the dimensional stability and, if necessary, a correction of the settings of the machine tool used for the machining should be possible.

This object is in each case satisfied by the features of the independent claims.

A scroll vacuum pump according to the invention in accordance with the independent claim 1 is in particular characterized in that at least one spiral wall has a reduced thickness at a free end section, said reduced thickness being smaller than the thickness of a section of the spiral wall that is arranged upstream of the free end section and that merges into the free end section.

A scroll vacuum pump according to the invention in accordance with the independent claim 2 is in particular characterized in that at least one spiral wall has a free end section that has, at its radial outer side and/or at its radial inner side, a recess relative to a section of the spiral wall that is arranged upstream of the free end section and that merges into the free end section.

These two aspects of the invention are based on the idea of producing a respective end section of a spiral wall at the radial inner side and/or at the radial outer side such that spring-back effects can no longer lead to a part of the end section lying outside a respective predefined tolerance range. For this purpose, the end section is provided with a reduced thickness and/or with a recess during the production, i.e. more material is removed at the end section than would be necessary with a stiffer end section. It has been shown that the measures according to the invention avoid the initially described disadvantages, but do not impair the performance of the scroll vacuum pump in so doing.

In this respect, the thickness of the free end section does not necessarily have to be reduced, as is provided in the first aspect of the invention. According to the second aspect of the invention, the end section can be provided with a recess at its radial inner side or its radial outer side, which recess does not reduce the thickness of the entire end section if said end section, for example, has a radial extension at the oppositely disposed side, but nevertheless ensures that the end section at the respective side lies within a respective tolerance range after the machining despite an elastic deflection taking place during the machining.

The non-observance of predefined tolerances due to spring-back effects is thus avoided by the invention, which above all has the advantage that the results of checking measurements, which are, for example, obtained from automatic coordinate measurement machines, can be better automatically interpreted and, if necessary, can be implemented in correction settings of the respective processing machine. Manual interventions in this automatic optimization process by an operator are no longer necessary, which simplifies and speeds up the manufacturing process overall and makes it more cost-effective. A further advantage is that greater tolerances can also be predefined for the machining due to the reduced thickness or the recess, i.e. due to the greater material removal, which basically simplifies the manufacture.

Advantageous further developments of the invention are also set forth in the dependent claims, in the following description and in the drawing.

According to some embodiment examples, it can be provided that each free end section of each spiral wall has a reduced thickness or a recess.

Furthermore, it can be provided that the reduced thickness of the free end section over the entire wall height is smaller than the thickness of the section arranged upstream and/or that the recess extends over the entire wall height of the free end section.

In particular, it can be provided that the reduced thickness of the free end section is constant over the entire wall height and/or that the recess is constant over the entire wall height of the end section.

However, this is not absolutely necessary. The stiffness of the free end section is higher at the spiral base than in the region of the tip of the spiral wall. According to some embodiment examples, it can therefore be provided that the reduced thickness of the free end section decreases continuously from the spiral base up to the tip of the spiral wall, wherein, in particular at the spiral base, the free end section and the section of the spiral wall that is arranged upstream have the same thickness, or that the recess of the free end section decreases continuously from the tip of the spiral wall up to the spiral base, wherein the recess is in particular equal to zero at the spiral base.

According to some further developments of the invention, it can be provided that the free end section has a respective recess relative to the section arranged upstream both at the radial inner side and at the radial outer side of said free end section. Alternatively, according to some embodiment examples, it can be provided that the free end section has a recess relative to the section arranged upstream only at the radial inner side of the free end section.

Some further developments provide that the spiral wall has been produced by a chip-forming machining by means of a machine tool that has a rotating tool, in particular a milling tool, that is pressed during the machining against the radial inner side or against the radial outer side of the spiral wall to be produced. In particular, it is provided in this respect that the tool is guided during the machining on a path that predefines the reduced thickness and/or the recess at the end section of the spiral wall.

In this respect, it can be provided that a desired contour for the spiral wall is predefined in at least one plane extending perpendicular to the axis of rotation of the drive shaft, wherein the path for the tool is predefined such that the end section of the spiral wall remains within the desired contour, said end section being deflected by the tool during the machining and springing back after the machining.

In this respect, the desired contour in particular relates to a plane in which the tip of the spiral wall lies since, in this region, a deflection of the spiral wall is the greatest during the machining.

According to some embodiment examples, it is provided that the movable spiral component and the stationary spiral component are each made of aluminum or of a material containing aluminum.

Furthermore, it can be provided that the reduced thickness of the end section is between 85% and 98%, in particular between 92% and 95%, of the thickness of the section arranged upstream, or that the reduced thickness of the end section is 1/10 mm to 3/10 mm less than the thickness of the section arranged upstream. Alternatively or additionally, it can be provided that the recess of the end section is between 0.5/10 mm and 2/10 mm.

According to a specific example, an end section having a constant thickness can have a respective recess of 1/10 mm at both sides so that a reduction in the thickness by 2/10 mm results overall. For example, the thickness of the section arranged upstream can be in the range from 3.5 to 3.7 mm so that the reduced thickness of the end section lies in a range from 3.3 to 3.5 mm, which corresponds, for instance, to 94% of the thickness of the section arranged upstream.

According to some embodiment examples, it can be provided that the length of the end section measured in the direction of extent of the spiral wall is in the range from 3 mm to 10 mm.

In the method according to the invention for manufacturing a scroll vacuum pump as disclosed herein or for manufacturing a spiral component for a scroll vacuum pump as disclosed herein, it is provided that the spiral wall is produced by a chip-forming machining by means of a machine tool that has a rotating tool, in particular a milling tool, that is pressed during the machining against the radial inner side or against the radial outer side of the spiral wall to be produced.

The milling tool is in particular an end mill cutter, for example, a cylindrical milling cutter or a shell end mill.

Furthermore, it can be provided that the tool is guided during the machining on a path by which the reduced thickness and/or the recess at the end section of the spiral wall is predefined.

Furthermore, it can be provided that a desired contour for the spiral wall is predefined in at least one plane extending perpendicular to the axis of rotation of the drive shaft, and wherein the path on which the tool is guided during the machining is predefined such that the end section of the spiral wall remains within the desired contour, said end section being deflected by the tool during the machining and springing back after the machining.

In this respect, it is in particular provided that the path is predefined in dependence on the desired contour and the respective conditions. The respective conditions in particular relate to the mechanical properties of the spiral wall to be produced and to the force with which the tool is pressed against the inner side or the outer side of the spiral wall and, if applicable, to further parameters of the machine tool that are relevant for material removal. This results in the potential measure of the error caused by the springing back of the spiral wall, i.e. the potential deviation from a respective predefined tolerance, so that the path for the tool can be predefined accordingly in order to remove enough material from the spiral wall to be produced so that the springing back in fact does not cause a tolerance deviation.

Furthermore, it can be provided that different dimensional tolerances are predefined for the reduced thickness of the end section and/or for the recess of the end section, on the one hand, and for the thickness of the section arranged upstream of the end section, on the other hand. In particular, the dimensional tolerance can amount to +/− 1/10 mm in each case and can in particular be between +/− 1/100 mm and +/− 6/100 mm.

However, such dimensional tolerances are not absolutely necessary, i.e. other dimensional tolerances can also be predefined, i.e. the respective machine tool can also be operated with other cutting data.

The invention will be described in the following by way of example with reference to the drawing. There are shown:

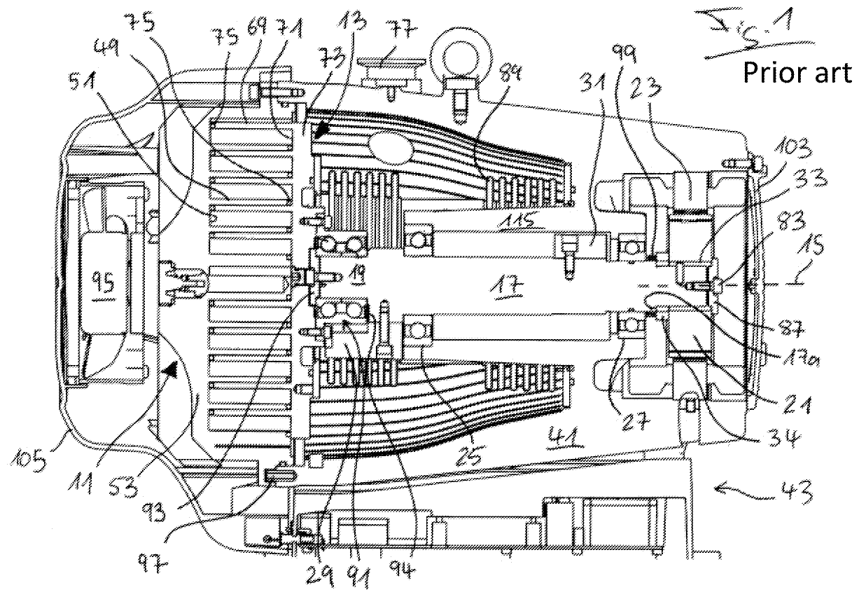

FIG. 1 an example of a conventional scroll vacuum pump to explain the basic design of such a scroll vacuum pump;

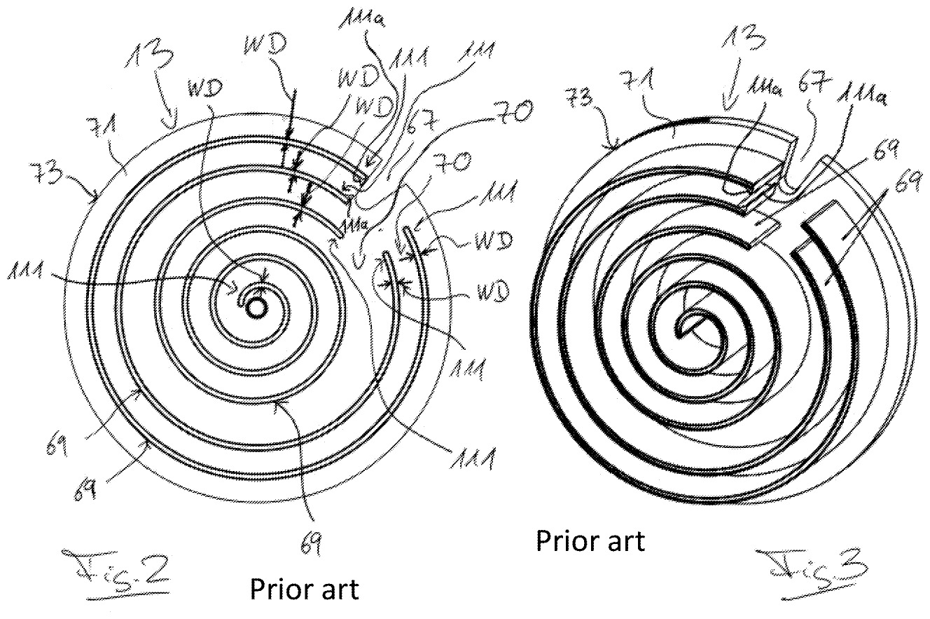

FIGS. 2 and 3 different views of a conventional movable spiral component of a scroll vacuum pump in accordance with FIG. 1 to explain the design of such a spiral component also designated as an orbiter;

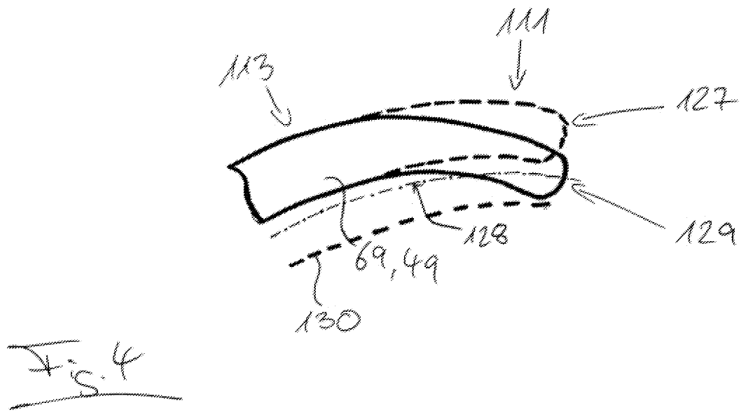

FIG. 4 a schematic representation to explain the problem of the springing back of the end sections of spiral walls;

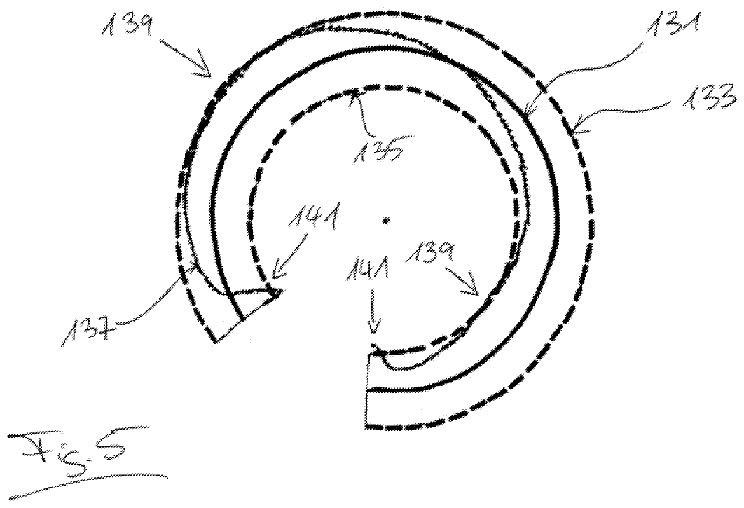

FIG. 5 a representation to explain the influences of spring-back effects in accordance with FIG. 4;

FIG. 6 a part view of a movable spiral component according to an embodiment example of the invention;

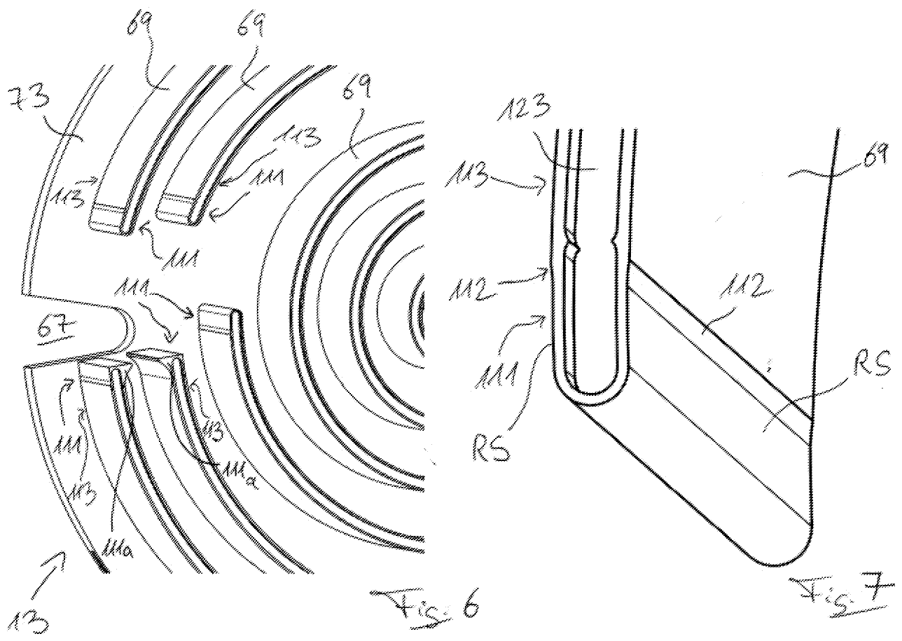

FIG. 7 an enlarged representation of an end section of a spiral wall of the spiral component of FIG. 6; and

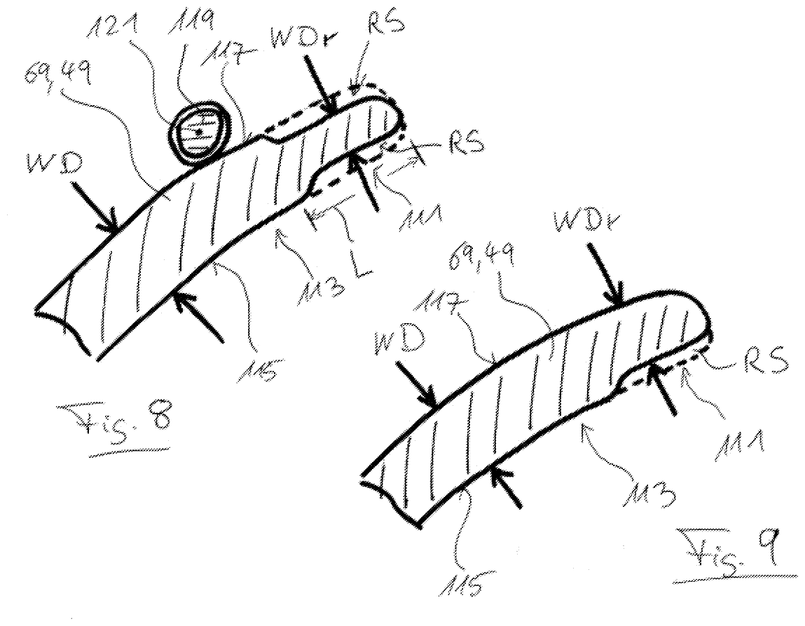

FIGS. 8 and 9 schematic representations to explain a manufacture according to the invention of spiral walls configured according to the invention.

FIG. 1 shows a conventional scroll vacuum pump having a basic design that is described below. The design and mode of operation of such a scroll vacuum pump are known to the skilled person. This conventional scroll vacuum pump can be further developed in a manner according to the invention. This is explained with reference to FIGS. 6 to 9.

The scroll vacuum pump in accordance with FIG. 1 comprises a pump system having a stationary spiral component 11 and a movable spiral component 13 that cooperate in a pump-active manner during the operation. The scroll vacuum pump further comprises a drive shaft 17 that rotates about an axis of rotation 15 during operation and that has an eccentric section 19 for driving the movable spiral component 13. Furthermore, the scroll vacuum pump is provided with an electric drive motor 21, 23 that serves to set the drive shaft 17 into rotation about the axis of rotation 15. The electric drive motor comprises a radially inner motor rotor 21, also called a rotor, and a radially outer motor stator 23.

The drive shaft 17 is rotatably supported at the pump housing 41 at two support points 25, 27 spaced apart in the axial direction. The front support point 25 is formed by a front rolling element bearing, which is configured as a fixed bearing, while the rear support point 27 is formed by a rear rolling element bearing that is configured as a floating bearing. To support the drive shaft 17, the pump housing 41 is provided with a sleeve-shaped section that is also called the bearing sleeve 115 in the following. The two rolling element bearings 25, 27 are thus located radially between the drive shaft 17 and the bearing sleeve 115.

Both support points 25, 27 are located at the side of the drive motor 21, 23 facing the eccentric section 19 of the drive shaft 17. Thus, all the support points 25, 27 are located within the pump housing 41 in front of the drive motor 21, 23. In this respect, the support points 25, 27 are located in the atmospheric region of the pump, i.e. not in the region in which a vacuum prevails during the pump operation. The eccentric section 19 is connected in one piece to the front end of the drive shaft 17 and the drive motor 21, 23 is seated on the rear end of the drive shaft 17. Due to this design, the drive motor 21, 23 can be pushed onto the rear end of the drive shaft 17. The assembly and the replacement of the drive motor 21, 23 or parts of the drive motor 21, 23 are hereby simplified.

The balancing concept for balancing the rotating system, which inter alia comprises the drive shaft 17 and the movable spiral component 13, comprises a front balancing weight 29 and a rear balancing weight 31 that are attached to the drive shaft 17. The front balancing weight 29 is in this respect arranged in the region of the front end of the drive shaft 17 and the eccentric section 19. The rear balancing weight 31 is located in front of the rear support point 27 and thus in front of the drive motor.

Other balancing concepts are also possible in modifications of this basic design. For example, the rear balancing weight or an additional balancing weight can be arranged at the rear end of the drive shaft in the region of the drive motor.

Furthermore, a pressure element 87 that is placed at the end face onto the rear end of the drive shaft 17 is provided that is rotationally symmetrical and thus does not serve as a balancing weight.

The pressure element 87 is connected to the drive shaft 17 by means of a central screw 83. To adapt the outer diameter of the rear section of the drive shaft 17 to the inner diameter of the motor rotor 21, the rear section of the drive shaft 17 is provided with a sleeve element 33. The sleeve element 33 is clamped to the motor rotor 21 by means of the pressure element 87 and the central screw 83. The sleeve element 33 is fastened to the drive shaft 17 by means of a positioning pin 33a. Furthermore, a ring-shaped intermediate element 34 is arranged axially between a shoulder 17a formed at the drive shaft 17 and the motor rotor 21. The motor rotor 21 is clamped via the intermediate element 34 between the pressure element 87 and the shoulder 17a of the drive shaft 17 that serves as an abutment for the intermediate element 34. In the region of the shoulder 17a, a corrugated spring 99 is arranged between the floating bearing 27 forming the rear support point 27 and the intermediate element 34.

The drive motor 21, 23 is arranged completely within the pump housing 41, i.e. the drive motor 21, 23 is surrounded over its entire axial length by the pump housing 41 in the peripheral direction and therefore does not project to the rear. At its rear end, the pump housing 41 is closed by means of a separate motor cover 103.

The pump system having the stationary spiral component 11 and the movable spiral component 13 is located at the front end of the pump housing 41. The stationary spiral component 11, also called the spiral housing, is screwed at the end face onto the front end of the pump housing 41 and is surrounded by a hood 105 which is likewise attached to the pump housing 41 and in which a fan 95 is furthermore accommodated.

The movable spiral component 13 is supported at the eccentric section 19 via a flange bearing 91 configured as a rolling element bearing. A thrust washer 93 is located axially between the movable spiral component 13 and the eccentric section 19. A shim washer 94 is located between a peripheral shoulder of the drive shaft 17 at the transition into the eccentric section 19 and the flange bearing 91. The correct orientation in the peripheral direction between the stationary spiral component 11 and the pump housing 41 is ensured by a positioning pin 97. In modifications of this basic design, a plurality of positioning pins 79 can also be provided.

The stationary spiral component 11 comprises a spiral arrangement, which has spiral walls 49 and a spiral base 51, and a support 53 for the spiral arrangement, which support 53 forms the spiral base 51 with its side facing the movable spiral component 13. For example, two radially outer spiral walls 49 can be provided that lie on concentric circles and that are interrupted in the peripheral direction. A parallel pump structure of channels is hereby produced, which channels pump in parallel, are formed by the respective spiral grooves between the spiral walls 49 and merge into a pump channel that extends radially inwardly in a spiral shape, that is formed by a spiral groove extending in a spiral shape and that is bounded by a spiral wall 49 extending in a spiral shape.

The movable spiral component 13 likewise comprises a spiral arrangement, which has spiral walls 69 and a spiral base 71, and a plate-shaped support 73 for the spiral arrangement, which support 73 forms the spiral base 71 with its side facing the stationary spiral component 11. According to the spiral arrangement of the stationary spiral component 11, two radially outer spiral walls 69 can be provided that lie on concentric circles and that are interrupted in the peripheral direction in the region of a gas inlet, not shown. A radially inwardly disposed spiral wall 69 extends in a spiral shape.

Both the spiral walls 49 of the stationary spiral component 11 and the spiral walls 69 of the movable spiral component 13 are provided with an elongated sealing element 75 (tip seal) at their end facing away from the respective spiral base 51 or 71.

The above-described spiral arrangements of the two spiral components 11, 13 can also be configured differently.

The gas to be pumped enters the pump system comprising the two spiral components 11, 13 via an inlet flange 77 and is discharged via an outlet flange, not shown.

The pump housing 41 is supported on a base formed by an electronics housing 43. The pump housing 41 is screwed to the electronics housing 43. The electronics housing 43, not shown in full, is provided with feet, not shown, at its lower side. In the electronics housing 43, electronic equipment is accommodated that comprises electronic, electrical and electromechanical components that inter alia serve for the power supply and the control of the scroll vacuum pump.

Furthermore, the scroll vacuum pump comprises a gas ballast valve, not shown. In modifications of this basic design, a multi-stage gas ballast system can be provided instead of a gas ballast valve.

The eccentric drive formed by the drive shaft 17 having the eccentric section 19 is located within the pump housing 41 and is surrounded by a deformable sleeve in the form of a corrugated bellows 89. The corrugated bellows 89 serves, on the one hand, to seal the eccentric drive against the suction region of the scroll vacuum pump and, on the other hand, as a security against rotation for the movable spiral component 13. For this purpose, the corrugated bellows 89 is fastened to the side of the movable spiral component 13 facing the drive. The rear end of the corrugated bellows 89 is attached to a housing base within the pump housing 41 by means of screws.

FIGS. 2 and 3 show the movable spiral component 13 of the scroll vacuum pump of FIG. 1 and serve to explain the basic design of such a movable spiral component 13. Embodiments of a stationary spiral component according to the invention (not shown) can have a corresponding basic design.

The movable spiral component 13 comprises a spiral arrangement, which has spiral walls 69 and a spiral base 71, and a plate-shaped support 73 for the spiral arrangement. The two radially outer spiral walls 69 run on concentric circles, are interrupted in the peripheral direction in the region of a gas inlet 67 and-as already mentioned above-are likewise designated as spiral walls despite their semi-circular shape. A radially inwardly disposed spiral wall 69 extends in a spiral shape. The spiral walls 69 are provided with a sealing element 75 (tip seal), not shown here, at their end facing away from the spiral base 71.

A radially outer spiral groove 70 is provided between the two spiral walls 69 of part circle shape. A further spiral groove 70 extending in a spiral shape is bounded by the spiral-shaped spiral wall 69.

The spiral walls 69 each have two free end sections 111. The wall thickness WD of the spiral walls including the end sections 111 is—with the exception mentioned below—constant over the entire course in each case. Only the end sections 111 of the two spiral walls 69 of part circle shape that are located at the cut-out 67 are each provided with a radial extension 111a at their free end, wherein the end of the radially outer spiral wall 69 widens radially inwardly and the end of the inner spiral wall 69 widens radially outwardly. Consequently, the thickness of these two spiral walls 69 increases at these ends.

The problem of a springing back of a free end section 111 of a spiral wall 69, 49 of a spiral component, which spiral wall has been machined at its inner side, is shown purely for illustrative purposes in FIG. 4.

A spiral wall that is not radially deflected at its end section 111 during the machining by the machining tool, i.e. that so-to-say has an infinitely high rigidity, would assume the ideal position 127, shown as a dashed line in FIG. 4, with its end section subsequent to the machining, i.e. after the removal of the machining tool, and would thus lie within a tolerance limit 128 illustrated by a chain-dotted line. The original position 130 of the inner side of the spiral wall 69, 49 which the inner side occupies before the machining is illustrated by a dashed line in FIG. 4. This dashed line 130 has a constant distance from the inner side of the machined infinitely rigid spiral wall, i.e. the constant distance illustrates that in the case of an infinitely rigid spiral wall, the same material removal would also take place at the end section 111 of said spiral wall as at the section 113 arranged upstream. In practice, there is in fact the problem that, due to the elastic deformability of the spiral walls 69, 49 at their end sections 111, said spiral walls are deflected during the machining, whereby the machining tool, which is moved along a path predefined by the programming of the machine tool, removes less material than would be the case with an infinitely rigid spiral wall that does not yield to the machining tool. After the machining, the end section 111 deflected by the machining tool springs back and—since said end section 111 has not obtained the predefined desired contour, with which the tolerance limit 128 is matched, due to the insufficient material removal—assumes the actual position 129, which is shown by a solid line in FIG. 4, after the machining. This has the result that the end section 111 lies partly outside the tolerance limit 128.

FIG. 5 illustrates how the spring-back effects explained with reference to FIG. 4 can have an effect in practice during the manufacture of spiral components by means of a machine tool. During the control of the machine tool, a desired contour 131, for which a tolerance range is specified that is defined by a radially outer tolerance limit 133 and a radially inner tolerance limit 135, is predefined for the inner side of the spiral wall to be produced, for example.

The desired contour 131 and the two tolerance limits 133, 135 are shown here as part circles and thus with respect to spiral walls of part-circle shape. For a spiral wall extending in a spiral shape, these lines accordingly extend in a spiral shape.

Ideally, the inner side of the manufactured spiral wall lies on the desired contour 131. In the case of a spiral wall that is actually manufactured and that complies with the predefined dimensions within the predefined tolerance, the inner side 137 of said spiral wall (measured inner side 137) that results from a measurement by means of a coordinate measurement machine is within the tolerance limits 133, 135. With the exception of the end sections, this measured inner side 137 is substantially only shifted with respect to the desired contour 131, wherein two “critical regions” 139 are shown at which the measured inner side 137 lies close to or on the respective tolerance limit 133 or 135.

However, the above-explained spring-back effects at the end sections of the manufactured spiral wall lead to “interferences” 141 during the measurement in the form of an exceeding of the tolerance limit 135. However, this exceeding does not occur due to a merely non-optimal setting of the machine tool, but rather precisely due to the spring-back effects explained. An automatic correction of the machine tool could recognize the above-mentioned displacement of the measured inner side 137 with respect to the desired contour 131 and could carry out a corresponding automatic correction of the machine tool if the interference regions 141 were not present. In practice, these interferences caused by the springing back make an automatic measurement correction impossible so that it has to be ensured by a manual intervention by an operator that the interference regions 141 are not included in the correction. Since—as explained in the introductory part—each spiral wall is measured after its manufacture and the setting of the machine tool is then corrected, if necessary, on the basis of these measurement results, the springing-back end sections of the spiral walls overall result in a delay in the manufacturing process.

A spiral component according to the invention-here using the example of a movable spiral component 13 (orbiter)-is shown in FIGS. 6 and 7. The end sections 111 of the spiral walls 69 have specifically been manufactured in a manner according to the invention. The end sections of the spiral walls of the stationary spiral component (spiral housing) can likewise be manufactured in this way.

In the embodiment example shown here, the end sections 111 without a radial extension at the end are provided at both sides, i.e. both at the radial inner side and at the radial outer side, with a respective recess RS extending over the entire wall height so that, overall, the free end sections 111 each have a reduced thickness WDr (cf. also FIGS. 8 and 9) that is smaller than the thickness WD of the section 113 of the spiral wall 69 that is arranged upstream of the free end section 111. The transitions 112 into the free end section 111 at the radial inner side and at the radial outer side can generally have any desired course.

Those end sections 111 which are provided with a radial extension 111a at the end each have a recess RS at the side facing away from the radial extension. Only at this side are these end sections 111 set back with respect to the section 113 of the spiral wall 69 that is arranged upstream.

FIG. 8 illustrates the method for manufacturing a spiral wall 69, 49 by means of a milling tool 119 rotating about an axis 121, for example an end mill. The conventional specification for manufacturing the free end section 111 of the spiral wall 69, 49 is indicated by the dashed line, according to which the free end section 111 has the same wall thickness WD as the section 113 arranged upstream. According to the invention, the specification for the machining of the free end section 113 now takes place such that the free end section 111 is provided with a recess RS at both the outer side 117 and the inner side 115 by means of the tool 119 during the machining. The free end section 111 is hereby set back relative to the section 113 arranged upstream both at the outer side 117 and at the inner side 115 so that a reduced wall thickness WDr results that is smaller than the wall thickness WD of the section 113 arranged upstream. The length L of the end section 111 having the reduced wall thickness WDr is preferably in the range from 3 mm to 10 mm.

According to an alternative embodiment example, which is shown schematically in FIG. 9, a reduced wall thickness WDr can also be produced by producing a recess RS only at one side of the free end section 111—here at the radial inner side 115—by means of the machining tool, not shown here.

If an end section 111 provided with one or two such recesses RS springs back after the machining, the end section 111 remains within the desired contour not shown here, i.e. within the tolerance range, since more material is removed from the machining tool by the specification for the machining than without the specification for producing a reduced thickness WDr or one or two recesses RS.

The reduced wall thickness WDr or the recess or recesses RS are predefined with respect to their size in dependence on the respective conditions, i.e. in particular—as mentioned in the introductory part—in dependence on the mechanical properties of the spiral wall to be produced and on the machining parameters of the machine tool and in this respect in particular on the force with which the tool 119 (cf. FIG. 8) is pressed during the machining against the inner side 115 or the outer side 117 of the spiral wall 69, 49 to be manufactured.

### REFERENCE NUMERAL LIST

11 stationary spiral component, spiral housing

13 movable spiral component, orbiter

15 axis of rotation

17 drive shaft

17a shoulder

19 eccentric section

21 motor rotor

23 motor stator

25 front support point (fixed bearing)

27 rear support point (floating bearing)

29 front balancing weight

31 rear balancing weight

33 sleeve element

34 intermediate element

41 pump housing

43 electronics housing

49 spiral wall of the stationary spiral component

51 spiral base

53 support

67 cut-out

69 spiral wall of the movable spiral component

70 spiral groove

71 spiral base

73 support

75 sealing element

77 inlet flange

83 central screw

87 pressure element

89 corrugated bellows

91 flange bearing

93 thrust washer

94 shim washer

95 fan

97 positioning pin

99 corrugated spring

103 motor cover

105 hood

111 end section

111a extension

112 transition

113 section arranged upstream

115 inner side

117 outer side

119 tool

121 axis of rotation

123 groove

127 ideal position of the end section

128 tolerance limit

129 actual position of the end section

130 original position of the inner side

131 desired contour

133 radially outer tolerance limit

135 radially inner tolerance limit

137 measured inner side

139 critical region

141 “interference” due to resilience

WDr

D thickness

RS recess

L length

1-15. (canceled)

16. A scroll vacuum pump, comprising:
a pump system that comprises a stationary spiral component and a movable spiral component cooperating with said stationary spiral component in a pump-active manner;
a drive shaft that rotates about an axis of rotation during operation and that has an eccentric section for driving the movable spiral component; and
an electric drive motor for the drive shaft,
wherein the movable spiral component comprises a spiral arrangement, which has spiral walls, spiral grooves bounded by said spiral walls and a spiral base forming the base of said spiral grooves, and a support for the spiral arrangement, said support cooperating with the eccentric section of the drive shaft,
wherein the stationary spiral component comprises a spiral arrangement, which has spiral walls and a spiral base, and a support for the spiral arrangement, and
wherein at least one spiral wall has a reduced thickness at a free end section, said reduced thickness being smaller than the thickness of a section of the spiral wall that is arranged upstream of the free end section and that merges into the free end section.

17. The scroll vacuum pump according to claim 16,
wherein the reduced thickness of the free end section over the entire wall height is smaller than the thickness of the section arranged upstream.

18. The scroll vacuum pump according to claim 16,
wherein the reduced thickness of the free end section is constant over the entire wall height, or
wherein the reduced thickness of the free end section decreases continuously from the spiral base up to a tip of the spiral wall.

19. The scroll vacuum pump according to claim 16,
wherein the free end section has a respective recess relative to the section arranged upstream both at a radial inner side and at a radial outer side of said free end section, or
wherein the free end section has a recess relative to the section arranged upstream only at the radial inner side of the free end section.

20. The scroll vacuum pump according to claim 16,
wherein the spiral wall has been produced by a chip-forming machining via a machine tool that has a rotating tool that is pressed during the machining against a radial inner side or against a radial outer side of the spiral wall to be produced.

21. The scroll vacuum pump according to claim 20,
wherein a contour for the spiral wall is predefined in at least one plane extending perpendicular to the axis of rotation of the drive shaft, and
wherein a path for the tool is predefined such that the end section of the spiral wall remains within the contour, said end section being deflected by the tool during the machining and springing back after the machining.

22. The scroll vacuum pump according to claim 16,
wherein the movable spiral component and the stationary spiral component are each made of aluminum or of a material containing aluminum.

23. The scroll vacuum pump according to claim 16,
wherein the reduced thickness of the end section is between 85% and 98% of the thickness of the section arranged upstream, or
wherein the reduced thickness of the end section is 1/10 mm to 3/10 mm less than the thickness of the section arranged upstream.

24. The scroll vacuum pump according to claim 16,
wherein a length of the end section measured in a direction of extent of the spiral wall is in a range from 3 mm to 10 mm.

25. A method for manufacturing one of a scroll vacuum pump, a stationary spiral component, and a movable spiral component, the scroll vacuum pump comprising
a pump system that comprises the stationary spiral component and the movable spiral component cooperating with said stationary spiral component in a pump-active manner;
a drive shaft that rotates about an axis of rotation during operation and that has an eccentric section for driving the movable spiral component; and
an electric drive motor for the drive shaft,
wherein the movable spiral component comprises a spiral arrangement, which has spiral walls, spiral grooves bounded by said spiral walls, and a spiral base forming the base of said spiral grooves, and a support for the spiral arrangement, said support cooperating with the eccentric section of the drive shaft,
wherein the stationary spiral component comprises a spiral arrangement, which has spiral walls and a spiral base, and a support for the spiral arrangement, and
wherein at least one spiral wall includes:
a reduced thickness at a free end section, said reduced thickness being smaller than the thickness of a section of the spiral wall that is arranged upstream of the free end section and that merges into the free end section, or
a recess at the free end section at a radial outer side and/or at a radial inner side of the spiral wall, the recess being relative to the section of the spiral wall that is arranged upstream of the free end section and that merges into the free end section, the method comprising:
producing the spiral wall by a chip-forming machining via a machine tool that has a rotating tool that is pressed during the machining against the radial inner side or against the radial outer side of the spiral wall to be produced.

26. The method according to claim 25,
wherein the tool is guided during the machining on a path by which the reduced thickness or the recess is predefined.

27. A scroll vacuum pump, comprising:
a pump system that comprises a stationary spiral component and a movable spiral component cooperating with said stationary spiral component in a pump-active manner;
a drive shaft that rotates about an axis of rotation during operation and that has an eccentric section for driving the movable spiral component; and
an electric drive motor for the drive shaft,
wherein the movable spiral component comprises a spiral arrangement, which has spiral walls, spiral grooves bounded by said spiral walls, and a spiral base forming the base of said spiral grooves, and a support for the spiral arrangement, said support cooperating with the eccentric section of the drive shaft,
wherein the stationary spiral component comprises a spiral arrangement, which has spiral walls and a spiral base, and a support for the spiral arrangement, and
wherein at least one spiral wall has a free end section that has, at a radial outer side and/or at a radial inner side of the spiral wall, a recess relative to a section of the spiral wall that is arranged upstream of the free end section and that merges into the free end section.

28. The scroll vacuum pump according to claim 27,
wherein the recess extends over the entire wall height of the free end section.

29. The scroll vacuum pump according to claim 27,
wherein the recess is constant over the entire wall height of the end section, or
wherein the recess of the free end section decreases continuously from a tip of the spiral wall up to the spiral base.

30. The scroll vacuum pump according to claim 27,
wherein the free end section has a respective recess relative to the section arranged upstream both at the radial inner side and at the radial outer side of said free end section, or
wherein the free end section has a recess relative to the section arranged upstream only at the radial inner side of the free end section.

31. The scroll vacuum pump according to claim 27,
wherein the spiral wall has been produced by a chip-forming machining via a machine tool that has a rotating tool that is pressed during the machining against the radial inner side or against the radial outer side of the spiral wall to be produced.

32. The scroll vacuum pump according to claim 31,
wherein a contour for the spiral wall is predefined in at least one plane extending perpendicular to the axis of rotation of the drive shaft, and wherein a path for the tool is predefined such that the end section of the spiral wall remains within the contour, said end section being deflected by the tool during the machining and springing back after the machining.

33. The scroll vacuum pump according to claim 27,
wherein the movable spiral component and the stationary spiral component are each made of aluminum or of a material containing aluminum.

34. The scroll vacuum pump according to claim 27,
wherein the recess of the end section is between 0.5/10 mm and 2/10 mm.

35. The scroll vacuum pump according to claim 27,
wherein a length of the end section measured in a direction of extent of the spiral wall is in a range from 3 mm to 10 mm.
